(19) United States
(12) Patent Application Publication
(10) Pub. No.: US 2026/0025691 A1
(43) Pub. Date: Jan. 22, 2026

(54) METHOD AND APPARATUS FOR MEASUREMENTS REPORTING IN A WIRELESS COMMUNICATION SYSTEM

(71) Applicant: LG ELECTRONICS INC., Seoul (KR)

(72) Inventors: Myoungsoo KIM, Seoul (KR); Sunghoon JUNG, Seoul (KR); Hongsuk KIM, Seoul (KR)

(73) Assignee: LG ELECTRONICS INC., Seoul (KR)

(21) Appl. No.: 18/997,779

(22) PCT Filed: Aug. 4, 2023
(86) PCT No.: PCT/KR2023/011452

§ 371 Date: Jan. 22, 2025

Related U.S. Application Data
(60) Provisional application No. 63/395,869, filed on Aug. 8, 2022.

(51) Int. Cl. H04W 24/10

(52) U.S. Cl. CPC H04W 24/10

(57) ABSTRACT

A method and an apparatus for measurements reporting in a wireless communication system are provided. The method comprises: determining (i) a first list satisfying a first report condition related to the first measurement ID and (ii) a second list satisfying a second report condition related to the second measurement ID; and based on a number of elements included in any one of the first list and the second list being equal to or greater than a threshold, transmitting a measurement report including (i) information related to the first list and the second list and (ii) information related to the first measurement ID and the second measurement ID.

### CROSS-REFERENCE TO RELATED APPLICATION(S)

This application is the National Stage filing under 35 U.S.C. 371 of International Application No. PCT/KR2023/011452, filed on Aug. 4, 2023, which claims the benefit of U.S. Provisional Application No. 63/395,869, filed on Aug. 8, 2022, the contents of which are all incorporated by reference herein in their entirety.

### TECHNICAL FIELD

The present disclosure relates to a method and apparatus for measurements reporting in a wireless communication system.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

### SUMMARY

Since aerial UEs experience line-of-sight propagation conditions to more cells as the altitude increase, faraway cells become more visible to aerial UEs. So, aerial UEs will receive interference from more cells in the downlink and will cause interference to more cells in the uplink.

In LTE, a threshold of the number of triggering cells (numberOfTriggeringCells) was introduced to prevent a lot of measurement reports as the altitude increases. As per the LTE specification, UE can send a measurement report when the number of cells satisfying a reporting configuration for the corresponding measurement identity is larger than the threshold. However, this legacy procedure is insufficient to inform the downlink interference to the network.

Thus, a method for sending a measurement report efficiently considering downlink interference while reducing uplink interference with numberOfTriggeringCells is needed.

By considering the total number of cells triggered from each reporting condition, the UE can report the measurement report to inform the downlink interference. If the legacy procedure focuses on the uplink interference, it can be complementary for informing the downlink interference.

Therefore, studies for measurements reporting in a wireless communication system are required.

In an aspect, a method performed by a wireless device in a wireless communication system is provided. The method comprises: determining (i) a first list satisfying a first report condition related to the first measurement ID and (ii) a second list satisfying a second report condition related to the second measurement ID; and based on a number of elements included in any one of the first list and the second list being equal to or greater than a threshold, transmitting a measurement report including (i) information related to the first list and the second list and (ii) information related to the first measurement ID and the second measurement ID.

In another aspect, an apparatus for implementing the above method is provided.

The present disclosure can have various advantageous effects.

According to some embodiments of the present disclosure, a wireless device could efficiently perform measurements reporting considering at least two measurement conditions.

For example, the UE may report downlink interference by reporting a measurement report in consideration of the total number of cells triggered in each reporting condition. If the legacy procedure focuses on uplink interference, it can be a supplement to inform downlink interference.

For example, even if the number of triggering cells independently considered for each reporting condition is not sufficient, the UE can efficiently report DL interference by considering the total number of triggering cells that satisfy each reporting condition.

According to some embodiments of the present disclosure, a wireless network system could provide an efficient solution for measurements reporting considering at least two measurement conditions.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of measurement reporting.

FIG. 11 shows an example of UE information procedure.

FIG. 12 shows an example of UE Assistance Information.

FIG. 13 shows an example of event A3.

FIG. 14 shows an example of event A5.

FIG. 15 shows an example of a method for measurements reporting in a wireless communication system, according to some embodiments of the present disclosure.

FIG. 16 shows some an example of a method for measurements reporting in a wireless communication system, according to some embodiments of the present disclosure.

FIG. 17 shows an example of triggering measurement report by total number of triggering cell.

FIG. 18 shows an example of triggering measurement report by total number of triggering cell.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

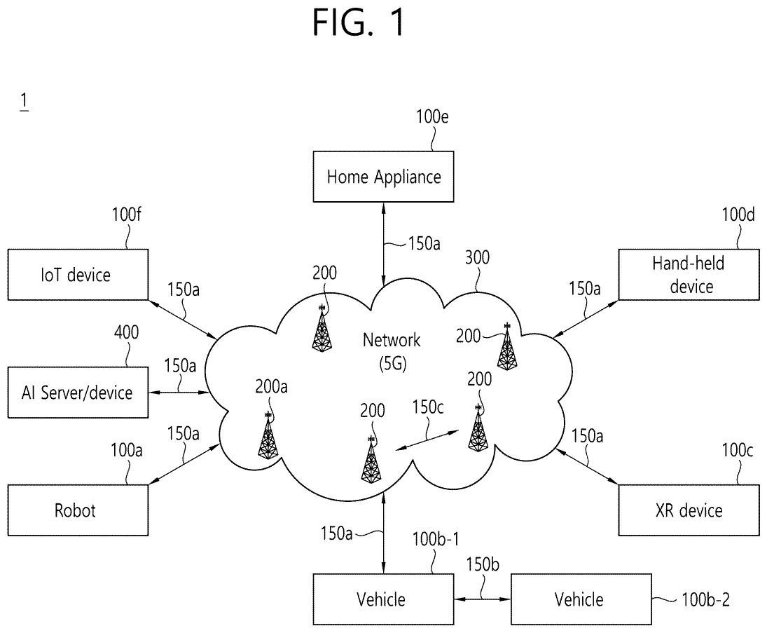

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

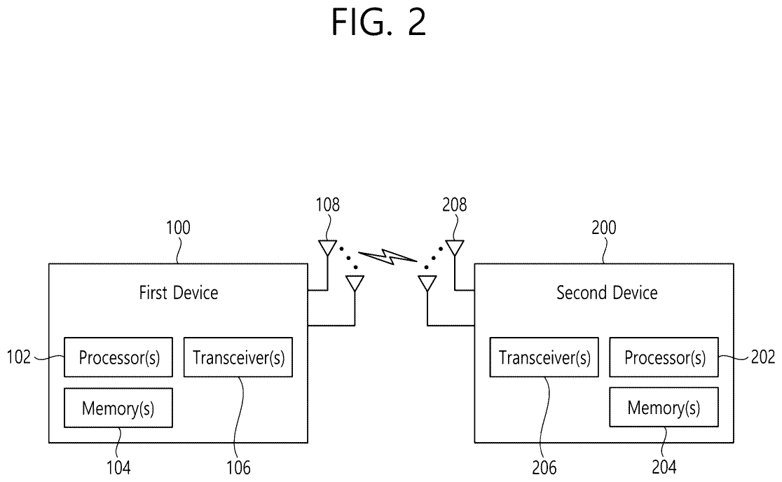

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

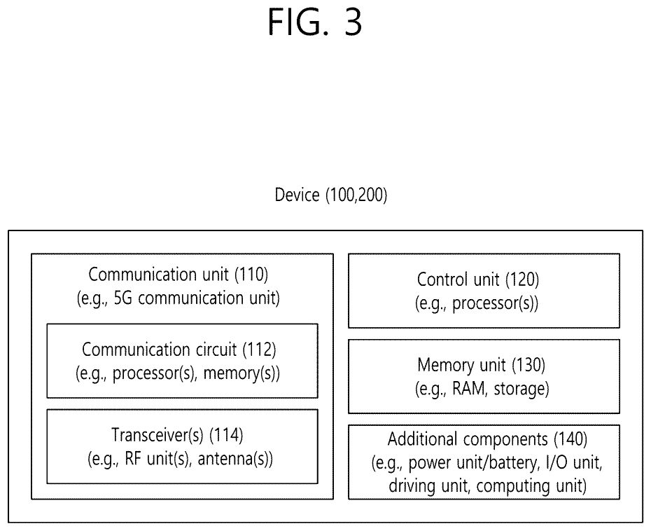

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

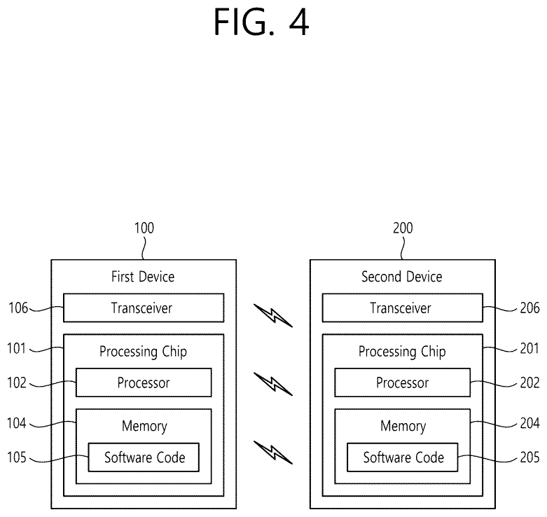

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

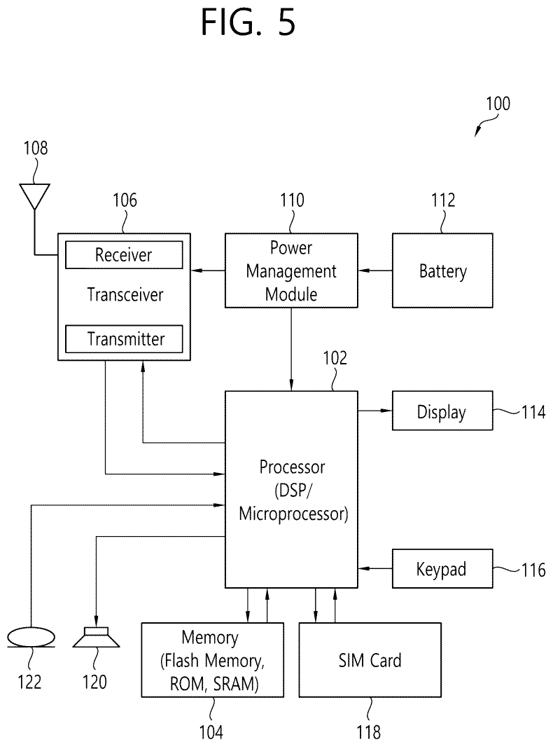

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

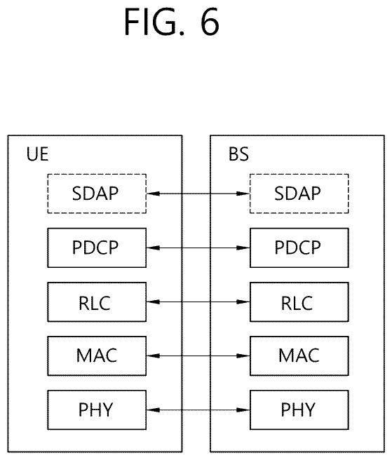

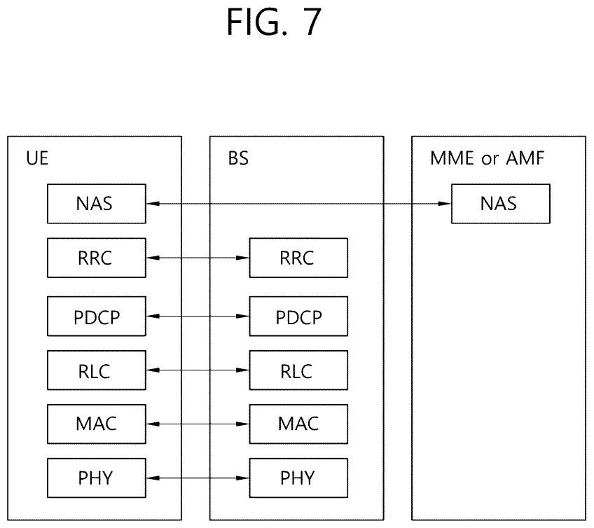

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QOS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

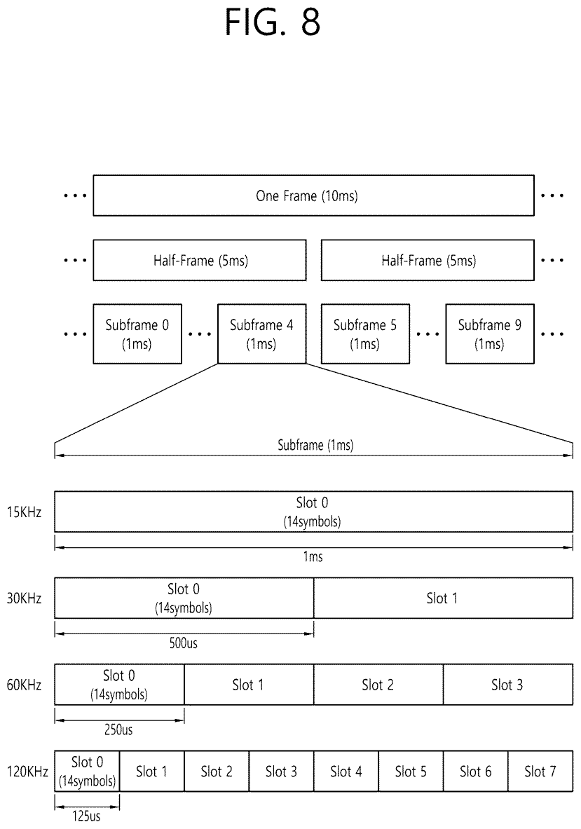

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2^{u}*15 kHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index I representing a symbol location relative to a reference point in the time domain. In the 3GPP based wireless communication system, an RB is defined by 12 consecutive subcarriers in the frequency domain.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}-1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding frequency | | |
|---|---|---|---|
| designation | range | Subcarrier Spacing | |
| FR1 | 450 MHz-6000 MHz | 15, 30, 60 | kHz |
| FR2 | 24250 MHz-52600 MHz | 60, 120, 240 | kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHZ, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 4

| Frequency Range | Corresponding frequency | | |
|---|---|---|---|
| designation | range | Subcarrier Spacing | |
| FR1 | 410 MHz-7125 MHz | 15, 30, 60 | kHz |
| FR2 | 24250 MHz-52600 MHz | 60, 120, 240 | kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

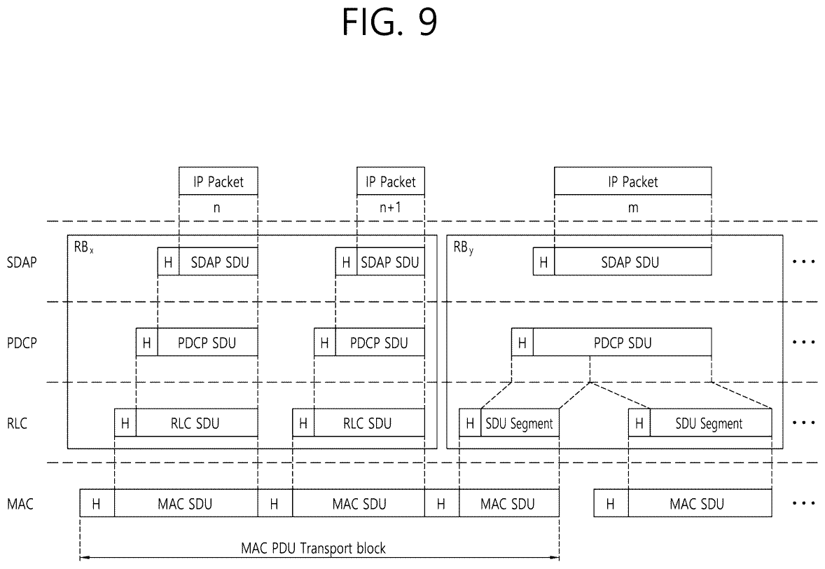

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Hereinafter, technical features related to the flight path are described. Parts of section 5.3.3.4, section 5.3.3.4a, section 5.3.5.4, section 5.3.7.5, section 5.5.4, section 5.5.5, and section 5.6.5 of 3GPP TS 36.331 v16.6.0 may be referred.

Operations related to reception of the RRCConnectionSetup by the UE are described.

The UE shall:
1> set the content of RRCConnectionSetupComplete message as follows:
2> if connecting as an RN:
3> include the rn-SubframeConfigReq;
2> set the dedicatedInfoNAS to include the information received from upper layers;
2> if the UE has flight path information available:
3> include flightPathInfoAvailable;

Operations related to reception of the RRCConnectionResume by the UE are described.

The UE shall:
1> consider the current cell to be the PCell;
1> set the content of RRCConnectionResumeComplete message as follows:
2> set the selectedPLMN-Identity to the PLMN selected by upper layers from the PLMN(s) included in the plmn-IdentityList in SystemInformationBlockType1;
2> set the dedicatedInfoNAS to include the information received from upper layers;
3> if the UE has flight path information available:
4> include flightPathInfoAvailable;

Operations related to reception of an RRCConnectionReconfiguration including the mobilityControlInfo by the UE (handover) are described.

If the RRCConnectionReconfiguration message includes the mobilityControlInfo and the UE is able to comply with the configuration included in this message, the UE shall:
1> set the content of RRCConnectionReconfigurationComplete message as follows:
2> if the UE has radio link failure or handover failure information available in VarRLF-Report and if the RPLMN is included in plmn-IdentityList stored in VarRLF-Report:
3> include rlf-InfoAvailable;
2> if the UE has MBSFN logged measurements available for E-UTRA and if the RPLMN is included in plmn-IdentityList stored in VarLogMeasReport and if T330 is not running:
3> include logMeasAvailableMBSFN;
2> if the UE has flight path information available
3> include flightPathInfoAvailable;

Operations related to Reception of the RRCConnectionReestablishment by the UE are described.

The UE shall:
2> if the UE is not a NB-IoT UE:
3> set the content of RRCConnectionReestablishmentComplete message as follows:
4> if the UE has radio link failure or handover failure information available in VarRLF-Report and if the RPLMN is included in plmn-IdentityList stored in VarRLF-Report:
5> include the rlf-InfoAvailable;
4> if the UE has MBSFN logged measurements available for E-UTRA and if the RPLMN is included in plmn-IdentityList stored in VarLogMeasReport and if T330 is not running:
5> include logMeasAvailableMBSFN;
4> else if the UE has logged measurements available for E-UTRA and if the RPLMN is included in plmn-IdentityList stored in VarLogMeasReport:
5> include the logMeasAvailable;
4> if the UE has connection establishment failure information available in VarConnEstFailReport and if the RPLMN is equal to plmn-Identity stored in VarConnEstFailReport:
5> include the connEstFailInfoAvailable;
4> if the UE has flight path information available:
5> include flightPathInfoAvailable;

Operations related to measurement report triggering are described.

If security has been activated successfully, the UE shall:
1> for each measId included in the measIdList within VarMeasConfig:
2> if the corresponding reportConfig includes a purpose set to reportStrongestCellsForSON:
3> consider any neighbouring cell detected on the associated frequency to be applicable;
2> else if the corresponding reportConfig includes a purpose set to reportCGI:
3> consider any neighbouring cell detected on the associated frequency/set of frequencies (GERAN) which has a physical cell identity matching the value of the cellForWhichToReportCGI included in the corresponding measObject within the VarMeasConfig to be applicable;
2> else if the corresponding reportConfig includes a purpose set to reportLocation:
3> consider only the PCell to be applicable;
( . . . )
2> if the triggerType is set to event, and if the corresponding reportConfig does not include numberOfTriggeringCells, and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig, while the VarMeasReportList does not include a measurement reporting entry for this measId (a first cell triggers the event):
3> include a measurement reporting entry within the VarMeasReportList for this measId;
3> set the numberOfReportsSent defined within the VarMeasReportList for this measId to 0;
3> include the concerned cell(s) in the cellsTriggeredList defined within the VarMeasReportList for this measId;
3> if the UE supports T312 and if use T312 is included for this event and if T310 is running:
4> if T312 is not running:
5> start timer T312 with the value configured in the corresponding measObject;
3> initiate the measurement reporting procedure;
2> if the triggerType is set to event, and if the corresponding reportConfig does not include numberOfTriggeringCells, and if the entry condition applicable for this event, i.e. the event corresponding with the eventId of the corresponding reportConfig within VarMeasConfig, is fulfilled for one or more applicable cells not included in the cellsTriggeredList for all measurements after layer 3 filtering taken during timeToTrigger defined for this event within the VarMeasConfig (a subsequent cell triggers the event):
3> set the numberOfReportsSent defined within the VarMeasReportList for this measId to 0;
3> include the concerned cell(s) in the cellsTriggeredList defined within the VarMeasReportList for this measId;
3> if the UE supports T312 and if use T312 is included for this event and if T310 is running:
4> if T312 is not running:
5> start timer T312 with the value configured in the corresponding measObject;
3> initiate the measurement reporting procedure;
( . . . )
2> if the triggerType is set to event and if the corresponding reportConfig includes numberOfTriggeringCells, and if the entry condition applicable for this event, i.e. the event corresponding with the eventId of the corresponding reportConfig within VarMeasConfig, is fulfilled for one or more applicable cells for all measurements after layer 3 filtering taken during time ToTrigger defined for this event within the VarMeasConfig:
3> If the VarMeasReportList does not include a measurement reporting entry for this measId (a first cell triggers the event):
4> include a measurement reporting entry within the VarMeasReportList for this measId;
3> If the number of cells(s) in the cellsTriggeredList is larger than or equal to numberOfTriggeringCell:
4> include the concerned cell(s) in the cellsTriggeredList defined within the VarMeasReportList for this measId;
3> else:
4> include the concerned cell(s) in the cellsTriggeredList defined within the VarMeasReportList for this measId;
4> If the number of cells(s) in the cellsTriggeredList is larger than or equal to numberOfTriggeringCells:
5> initiate the measurement reporting procedure;
( . . . )
2> if the triggerType is set to event and if the leaving condition applicable for this event is fulfilled for one or more of the cells included in the cellsTriggeredList defined within the VarMeasReportList for this measId for all measurements after layer 3 filtering taken during time ToTrigger defined within the VarMeasConfig for this event:
3> remove the concerned cell(s) in the cellsTriggeredList defined within the VarMeasReportList for this measId;
3> if the UE supports T312 and if use T312 is included for this event and if T310 is running:
4> if T312 is not running:
5> start timer T312 with the value configured in the corresponding measObject;
3> if reportOnLeave is set to TRUE for the corresponding reporting configuration or if a6-ReportOnLeave is set to TRUE or if a4-a5-ReportOnLeave is set to TRUE for the corresponding reporting configuration:
4> initiate the measurement reporting procedure;
( . . . )
2> if the trigger Type is set to event and if the eventId is set to eventH1 or eventH2 and if the entering condition applicable for this event, i.e. the event corresponding with the eventId of the corresponding reportConfig within VarMeasConfig, is fulfilled during timeToTrigger defined within the VarMeasConfig for this event:
3> include a measurement reporting entry within the VarMeasReportList for this measId;
3> set the numberOfReportsSent defined within the VarMeasReportList for this measId to 0;
3> initiate the measurement reporting procedure;
2> if measRSSI-ReportConfig is included and if a (first) measurement result is available:
3> include a measurement reporting entry within the VarMeasReportList for this measId;
3> set the memberOfReportsSent defined within the VarMeasReportList for this measId to 0;
3> initiate the measurement reporting procedure immediately when RSSI sample values are reported by the physical layer after the first L1 measurement duration;
2> else if the purpose is included and set to reportStrongestCells, reportStrongestCellsForSON, reportLocation or sidelink and if a (first) measurement result is available:
3> include a measurement reporting entry within the VarMeasReportList for this measId;
3> set the memberOfReportsSent defined within the VarMeasReportList for this measId to 0;
3> if the purpose is set to reportStrongestCells and reportStrongestCSI-RSs is not included:
4> if the trigger Type is set to periodical and the corresponding reportConfig includes the ul-DelayConfig:
5> initiate the measurement reporting procedure immediately after a first measurement result is provided by lower layers;
( . . . )
3> else if the purpose is set to reportLocation:
4> initiate the measurement reporting procedure immediately after both the quantity to be reported for the PCell and the location information become available;
3> else if the purpose is set to sidelink:
4> initiate the measurement reporting procedure immediately after both the quantity to be reported for the PCell and the CBR measurement result become available;

Operations related to measurement reporting are described.

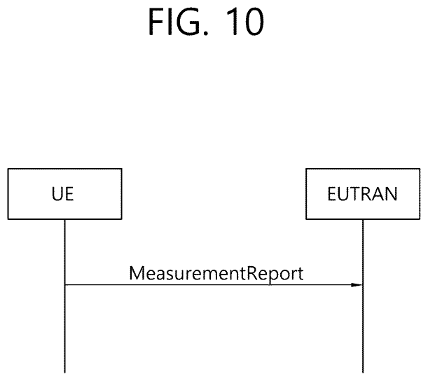

FIG. 10 shows an example of measurement reporting.

The purpose of this procedure is to transfer measurement results from the UE to E-UTRAN. The UE shall initiate this procedure only after successful security activation.

For the measId for which the measurement reporting procedure was triggered, the UE shall set the measResults within the MeasurementReport message as follows:
1> set the measId to the measurement identity that triggered the measurement reporting;
1> set the measResultPCell to include the quantities of the PCell;
1> set the measResultServFreqList to include for each E-UTRA SCell that is configured, if any, within measResultSCell the quantities of the concerned SCell, if available according to performance requirements, except if purpose for the reportConfig associated with the measId that triggered the measurement reporting is set to reportLocation;
1> if the reportConfig associated with the measId that triggered the measurement reporting includes reportAddNeighMeas:
2> for each E-UTRA serving frequency for which measObjectId is referenced in the measIdList, other than the frequency corresponding with the measId that triggered the measurement reporting:
3> set the measResultServFreqList to include within measResultBestNeighCell the physCellId and the quantities of the best non-serving cell, based on RSRP, on the concerned serving frequency;
1> if the trigger Type is set to event; and if the corresponding measObject concerns NR; and if eventId is set to eventB1 or eventB2; or
1> if the triggerType is set to event; and if eventId is set to eventA3 or eventA4 or eventA5:
2> if purpose for the reportConfig associated with the measId that triggered the measurement reporting is set to a value other than reportLocation:
3> set the measResultServFreqListNR to include for each NR serving frequency, if any, the following:
4> set measResultSCell to include the available results of the NR serving cell;
4> if the reportConfig associated with the measId that triggered the measurement reporting includes reportAddNeighMeas:
5> set measResultBestNeighCell to include the available results of the best non-serving cell, ordered based on the quantity determined;
5> for each (serving or neighbouring) cell for which the UE reports results according to the previous, additionally include available beam results according to the following:
6> if maxReportRS-Index is configured, set measResultCellRS-Index to include available results of up to maxReportRS-Index beams, ordered based on the quantity determined;
1> if there is at least one applicable neighbouring cell to report:
2> set the measResultNeighCells to include the best neighbouring cells up to maxReportCells in accordance with the following:
3> if the trigger Type is set to event:
4> include the cells included in the cellsTriggeredList as defined within the VarMeasReportList for this measId;
3> else:
4> include the applicable cells for which the new measurement results became available since the last periodical reporting or since the measurement was initiated or reset;
( . . . )
1> if uplink PDCP delay results are available:
2> set the ul-PDCP-DelayResultList to include the uplink PDCP delay results available;
1> if the includeLocationInfo is configured in the corresponding reportConfig for this measId or if purpose for the reportConfig associated with the measId that triggered the measurement reporting is set to reportLocation; and detailed location information that has not been reported is available, set the content of the locationInfo as follows:
2> include the locationCoordinates;
2> if available, include the gnss-TOD-msec, except if purpose for the reportConfig associated with the measId that triggered the measurement reporting is set to reportLocation;
2> include the heightCoordinates, if available;
( . . . )
1> if the trigger Type is set to event; and if eventId is set to eventH1 or eventH2:
2> set the heightUE to include the altitude of the UE;
1> increment the numberOfReportsSent as defined within the VarMeasReportList for this measId by 1;
1> stop the periodical reporting timer, if running;
1> if the numberOfReportsSent as defined within the VarMeasReportList for this measId is less than the reportAmount as defined within the corresponding reportConfig for this measId:
2> start the periodical reporting timer with the value of reportInterval as defined within the corresponding reportConfig for this measId;
( . . . )
2> submit the MeasurementReport message to lower layers for transmission, upon which the procedure ends;

Operations related to UE information are described.

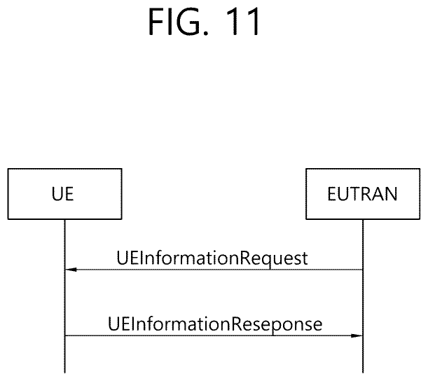

FIG. 11 shows an example of UE information procedure.

The UE information procedure is used by E-UTRAN to request the UE to report information.

E-UTRAN initiates the procedure by sending the UEInformationRequest message. E-UTRAN should initiate this procedure only after successful security activation.

Upon receiving the UEInformationRequest message, the UE shall, only after successful security activation:
> if flightPathInfoReq field is present and the UE has flight path information available:
2> include the flightPathInfoReport and set it to include the list of waypoints along the flight path;
2> if the include TimeStamp is set to TRUE:
3> set the field timeStamp to the time when UE intends to arrive to each waypoint if this information is available at the UE;

For example, UEInformationRequest message may include flightPathInfoReq-r15 and nonCriticalExtension. FlightPathInfoReq-r15 may include FlightPathInfoReportConfig-r15.

For example, UEInformationResponse message may include (i) measResultListIdle-r15 (MeasResultListIdle-r15), (ii) flightPathInfoReport-r15 (FlightPathInfoReport-r15), and (iii) nonCriticalExtension (UEInformationResponse-v1610-IEs).

For example, FlightPathInfoReport-r15 is configured as below:

| | |
|---|---|
| FlightPathInfoReport-r15 ::= | SEQUENCE { |

flightPath-r15 SEQUENCE (SIZE (1..maxWayPoint-r15)) OF
WayPointLocation-r15,

| | |
|---|---|
| nonCriticalExtension | SEQUENCE { } |

}

For example, WayPointLocation-r15 is configured as below:

| | |
|---|---|
| WayPointLocation-r15 ::= | SEQUENCE { |
| wayPointLocation-r15 LocationInfo-r10, | |
| timeStamp-r15 AbsoluteTimeInfo-r10 | |
| } | |

Table 5 shows an example of LocationInfo information element.

The IE LocationInfo is used to transfer detailed location information available at the UE to correlate measurements and UE position information.

TABLE 5
-- ASN1START

| LocationInfo-r10 ::= | SEQUENCE { | |
|---|---|---|
| locationCoordinates-r10 | | CHOICE { |
| | ellipsoid-Point-r10 | OCTET |

STRING,

| | |
|---|---|
| ellipsoidPointWithAltitude-r10 | OCTET STRING, |

...,

ellipsoidPointWithUncertaintyCircle-r11

OCTET STRING,

ellipsoidPointWithUncertaintyEllipse-r11

OCTET STRING,

| ellipsoidPointWithAltitudeAndUncertaintyEllipsoid-r11 | OCTET STRING, |
|---|---|
| ellipsoidArc-r11 | |
| OCTET STRING, | |
| polygon-r11 | |
| OCTET STRING | }, |

| | |
|---|---|
| horizontal Velocity-r10 | OCTET STRING |

OPTIONAL,

| | |
|---|---|
| gnss-TOD-msec-r10 | OCTET STRING |

OPTIONAL,

...,

| | | |
|---|---|---|
| [[ | verticalVelocityInfo-r15 | CHOICE { |
| | verticalVelocity-r15 | OCTET STRING, |
| | verticalVelocityAndUncertainty-r15 | OCTET STRING |
| } | OPTIONAL | ]] |

}
-- ASN1STOP

Hereinafter, technical features related to support for Aerial UE communication are described. Parts of section 23.17 of 3GPP TS 36.300 v16.5.0 may be referred. E-UTRAN based mechanisms providing LTE connection to UEs capable of Aerial communication are supported via the following functionalities:
subscription-based Aerial UE identification and authorization.
height reporting based on the event that the UE's altitude has crossed a network-configured reference altitude threshold.
interference detection based on a measurement reporting that is triggered when a configured number of cells (i.e. larger than one) fulfills the triggering criteria simultaneously.
signalling of flight path information from UE to E-UTRAN.
Location information reporting, including UE's horizontal and vertical velocity.

### <Subscription Based Identification of Aerial UE Function>

Support of Aerial UE function is stored in the user's subscription information in HSS. HSS transfers this information to the MME during Attach, Service Request and Tracking Area Update procedures.

The subscription information can be provided from the MME to the eNB via the S1 AP Initial Context Setup Request during Attach, Tracking Area Update and Service Request procedures. In addition, for X2-based handover, the source eNodeB can include the subscription information in the X2-AP Handover Request message to the target eNodeB.

For the intra and inter MME S1 based handover, the MME provides the subscription information to the target eNB after the handover procedure.

### <Height Based Reporting for Aerial UE Communication>

An aerial UE can be configured with event based height reporting. UE sends height report when the altitude of the aerial UE is above or below a configured threshold. The report contains height and location if configured.

### <Interference Detection and Mitigation for Aerial UE Communication>

For interference detection, an aerial UE can be configured with RRM event A3, A4 or A5 that triggers measurement report when individual (per cell) RSRP values for a configured number of cells fulfill the configured event. The report contains RRM results and location if configured.

For interference mitigation an aerial UE can be configured with a dedicated UE-specific alpha parameter for PUSCH power control.

### <Flight Path Information Reporting>

E-UTRAN can request a UE to report flight path information consisting of a number of waypoints defined as 3D locations. A UE reports up to configured number of waypoints if flight path information is available at the UE. The report can consist also time stamps per waypoint if configured in the request and if available at the UE.

### <Location Reporting for Aerial UE Communication>

Location information for Aerial UE communication can include horizontal and vertical speed if configured. Location information can be included in RRM report and in height report.

Hereinafter, technical features related to Measurement report triggering are described. Parts of section 5.5.4 of 3GPP TS 38.331 v17.0.0 may be referred.

Event A1 (Serving Becomes Better than Threshold)

The UE shall:
1> consider the entering condition for this event to be satisfied when condition A1-1, as specified below, is fulfilled;
1> consider the leaving condition for this event to be satisfied when condition A1-2, as specified below, is fulfilled;
1> for this measurement, consider the NR serving cell corresponding to the associated measObjectNR associated with this event.

$$\begin{matrix}Inequality A1 - 1 ( Entering condition ) & \\ Ms - Hys > Thresh & \end{matrix}$$

$$\begin{matrix}Inequality A1 - 2 ( Leaving condition ) & \\ Ms + Hys < Thresh & \end{matrix}$$

Event A2 (Serving Becomes Worse than Threshold)

The UE shall:
1> consider the entering condition for this event to be satisfied when condition A2-1, as specified below, is fulfilled;
1> consider the leaving condition for this event to be satisfied when condition A2-2, as specified below, is fulfilled;
1> for this measurement, consider the serving cell indicated by the measObjectNR associated to this event.

$$\begin{matrix}Inequality A2 - 1 ( Entering condition ) & \\ Ms + Hys < Thresh & \end{matrix}$$

$$\begin{matrix}Inequality A2 - 2 ( Leaving condition ) & \\ Ms - Hys > Thresh & \end{matrix}$$

Event A3 (Neighbour Becomes Offset Better than SpCell)

The UE shall:
1> consider the entering condition for this event to be satisfied when condition A3-1, as specified below, is fulfilled;
1> consider the leaving condition for this event to be satisfied when condition A3-2, as specified below, is fulfilled;
1> use the SpCell for Mp, Ofp and Ocp.
The cell(s) that triggers the event has reference signals indicated in the measObjectNR associated to this event which may be different from the NR SpCell measObjectNR.

$$\begin{matrix}Inequality A3 - 1 ( Entering condition ) & \\ Mn + Ofn + Ocn - Hys > Mp + Ofp + Ocp + Off & \end{matrix}$$

$$\begin{matrix}Inequality A3 - 2 ( Leaving condition ) & \\ Mn + Ofn + Ocn + Hys < Mp + Ofp + Ocp + Off & \end{matrix}$$

Event A4 (Neighbour Becomes Better than Threshold)

The UE shall:
1> consider the entering condition for this event to be satisfied when condition A4-1, as specified below, is fulfilled;
1> consider the leaving condition for this event to be satisfied when condition A4-2, as specified below, is fulfilled.

$$\begin{matrix}Inequality A4 - 1 ( Entering condition ) & \\ Ms + Ofn + Ocn - Hys > Thresh & \end{matrix}$$

$$\begin{matrix}Inequality A4 - 2 ( Leaving condition ) & \\ Mn + Ofn + Ocn + Hys < Thresh & \end{matrix}$$

Event A5 (SpCell becomes worse than threshold1 and neighbour becomes better than threshold2)

The UE shall:
1> consider the entering condition for this event to be satisfied when both condition A5-1 and condition A5-2, as specified below, are fulfilled;
1> consider the leaving condition for this event to be satisfied when condition A5-3 or condition A5-4, i.e. at least one of the two, as specified below, is fulfilled;
1> use the SpCell for Mp.
The parameters of the reference signal(s) of the cell(s) that triggers the event are indicated in the measObjectNR associated to the event which may be different from the measObjectNR of the NR SpCell.

### Inequality A5-1 (Entering Condition 1)

$$Mp + Hys < Thresh 1$$

$$\begin{matrix}Inequality A5 - 2 ( Entering condition 2 ) & \\ Mn + Ofn + Ocn - Hys > Thresh 2 & \end{matrix}$$

$$\begin{matrix}Inequality A5 - 3 ( Leaving condition 1 ) & \\ Mp - Hys > Thresh 1 & \end{matrix}$$

$$\begin{matrix}Inequality A5 - 4 ( Leaving condition 2 ) & \\ Mn + Ofn + Ocn + Hys < Thresh 2 & \end{matrix}$$

Event A6 (Neighbour Becomes Offset Better than SCell)

The UE shall:
1> consider the entering condition for this event to be satisfied when condition A6-1, as specified below, is fulfilled;
1> consider the leaving condition for this event to be satisfied when condition A6-2, as specified below, is fulfilled;
1> for this measurement, consider the (secondary) cell corresponding to the measObjectNR associated to this event to be the serving cell.
The reference signal(s) of the neighbour(s) and the reference signal(s) of the SCell are both indicated in the associated measObjectNR.

$$\begin{matrix}Inequality A6 - 1 ( Entering condition ) & \\ Mn + Ofn - Hys > Ms + Ocs + Off & \end{matrix}$$

$$\begin{matrix}Inequality A6 - 2 ( Leaving condition ) & \\ Mn + Ofn + Hys < Ms + Ocs + Off & \end{matrix}$$

Event B1 (Inter RAT neighbour becomes better than threshold)

The UE shall:
1> consider the entering condition for this event to be satisfied when condition B1-1, as specified below, is fulfilled;
1> consider the leaving condition for this event to be satisfied when condition B1-2, as specified below, is fulfilled.

$$\begin{matrix}Inequality B1 - 1 ( Entering condition ) & \\ Mn + Ofn + Ocn - Hys > Thresh & \end{matrix}$$

$$\begin{matrix}Inequality B1 - 2 ( Leaving condition ) & \\ Mn + Ofn + Ocn + Hys < Thresh & \end{matrix}$$

Event B2 (PCell Becomes Worse than Threshold1 and Inter RAT Neighbour Becomes Better than Threshold2)

The UE shall:
1> consider the entering condition for this event to be satisfied when both condition B2-1 and condition B2-2, as specified below, are fulfilled;
1> consider the leaving condition for this event to be satisfied when condition B2-3 or condition B2-4, i.e. at least one of the two, as specified below, is fulfilled;

$$\begin{matrix}Inequality B2 - 1 ( Entering condition 1 ) & \\ Mp + Hys < Thresh 1 & \end{matrix}$$

$$\begin{matrix}Inequality B2 - 2 ( Entering condition 2 ) & \\ Mn + Ofn + Ocn - Hys > Thresh 2 & \end{matrix}$$

$$\begin{matrix}Inequality B2 - 3 ( Leaving condition 1 ) & \\ Mp - Hys > Thresh 1 & \end{matrix}$$

$$\begin{matrix}Inequality B2 - 4 ( Entering condition 2 ) & \\ Mn + Ofn + Ocn + Hys < Thresh 2 & \end{matrix}$$

Event I1 (Interference Becomes Higher than Threshold)

The UE shall:
1> consider the entering condition for this event to be satisfied when condition I1-1, as specified below, is fulfilled;
1> consider the leaving condition for this event to be satisfied when condition I1-2, as specified below, is fulfilled.

$$Inequality I 1 - 1 ( Entering condition )$$

$$Mi - Hys > Thresh$$

$$Inequality I 1 - 2 ( Leaving condition )$$

$$Mi + Hys < Thresh$$

### Event C1 (the NR Sidelink Channel Busy Ratio is Above a Threshold)

The UE shall:
1> consider the entering condition for this event to be satisfied when condition C1-1, as specified below, is fulfilled;
1> consider the leaving condition for this event to be satisfied when condition C1-2, as specified below, is fulfilled;

$$Inequality C 1 - 1 ( Entering condition )$$

$$Ms - Hys > Thresh$$

$$Inequality C 1 - 2 ( Leaving condition )$$

$$Ms + Hys < Thresh$$

### Event C2 (the NR Sidelink Channel Busy Ratio is Below a Threshold)

The UE shall:
1> consider the entering condition for this event to be satisfied when condition C2-1, as specified below, is fulfilled;
1> consider the leaving condition for this event to be satisfied when condition C2-2, as specified below, is fulfilled;

$$Inequality C 2 - 1 ( Entering condition )$$

$$Ms + Hys < Thresh$$

$$Inequality C 2 - 2 ( Leaving condition )$$

$$Ms - Hys > Thresh$$

### Event D1

The UE shall:
1> consider the entering condition for this event to be satisfied when both condition D1-1 and condition D1-2, as specified below, is fulfilled;
1> consider the leaving condition for this event to be satisfied when condition D1-3 or condition D1-4, as specified below, is fulfilled;

$$Inequality D 1 - 1 ( Entering condition 1 )$$

$$Ml 1 - Hys > Thresh 1$$

$$Inequality D 1 - 2 ( Entering condition 2 )$$

$$Ml 2 + Hys < Thresh 2$$

$$Inequality D 1 - 3 ( Leaving condition 1 )$$

$$Ml 1 + Hys < Thresh 1$$

$$Inequality D 1 - 4 ( Leaving condition 2 )$$

$$Ml 2 - Hys > Thresh 2$$

### CondEvent T1

The UE shall:
1> consider the entering condition for this event to be satisfied when condition T1-1, as specified below, is fulfilled;
1> consider the leaving condition for this event to be satisfied when condition T1-2, as specified below, is fulfilled;

$$Inequality T 1 - 1 ( Entering condition )$$

$$Mt > Thresh 1$$

$$Inequality T 1 - 2 ( Leaving condition )$$

$$Mt > Thresh 1 + Duration$$

Event X1 (Serving L2 U2N Relay UE Becomes Worse than Threshold1 and NR Cell Becomes Better than Threshold2)

The UE shall:
1> consider the entering condition for this event to be satisfied when both condition X1-1 and condition X1-2, as specified below, are fulfilled;
1> consider the leaving condition for this event to be satisfied when condition X1-3 or condition X1-4, i.e. at least one of the two, as specified below, is fulfilled;

$$Inequality X 1 - 1 ( Entering condition 1 )$$

$$Mr + Hys < Thresh 1$$

$$Inequality X 1 - 2 ( Entering condition 2 )$$

$$Mn + Ofn + Ocn - Hys > Thresh 2$$

$$Inequality X 1 - 3 ( Leaving condition 1 )$$

$$Mr - Hys > Thresh 1$$

$$Inequality X 1 - 4 ( Leaving condition 2 )$$

$$Mn + Ofn + Ocn + Hys < Thresh 2$$

Event X2 (Serving L2 U2N Relay UE Becomes Worse than Threshold)

The UE shall:
1> consider the entering condition for this event to be satisfied when condition X2-1, as specified below, is fulfilled;
1> consider the leaving condition for this event to be satisfied when condition X2-2, as specified below, is fulfilled;

$$Inequality X 2 - 1 ( Entering condition )$$

$$Mr + Hys < Thresh$$

$$Inequality X 2 - 2 ( Leaving condition )$$

$$Mr - Hys > Thresh$$

Event Y1 (PCell Becomes Worse than Threshold1 and Candidate L2 U2N Relay UE Becomes Better than Threshold2)

The UE shall:
1> consider the entering condition for this event to be satisfied when both condition Y1-1 and condition Y1-2, as specified below, are fulfilled;
1> consider the leaving condition for this event to be satisfied when condition Y1-3 or condition Y1-4, i.e. at least one of the two, as specified below, is fulfilled;

$$Inequality Y 1 - 1 ( Entering condition 1 )$$

$$Mp + Hys < Thresh 1$$

$$Inequality Y 1 - 2 ( Entering condition 2 )$$

$$Mr - Hys > Thresh 2$$

$$Inequality Y 1 - 3 ( Leaving condition 1 )$$

$$Mp - Hys > Thresh 1$$

$$Inequality Y 1 - 4 ( Leaving condition 2 )$$

$$Mr + Hys < Thresh 2$$

Event Y2 (Candidate L2 U2N Relay UE Becomes Better than Threshold)

The UE shall:
1> consider the entering condition for this event to be satisfied when condition Y2-1, as specified below, is fulfilled;
1> consider the leaving condition for this event to be satisfied when condition Y2-2, as specified below, is fulfilled;

$$Inequality Y 2 - 1 ( Entering condition )$$

$$Mr - Hys > Thresh 2$$

$$Inequality Y 2 - 2 ( Leaving condition )$$

$$Mr + Hys < Thresh 2$$

Hereinafter, technical features related to UE Assistance Information are described. Parts of section 5.7.4 of 3GPP TS 36.300 v16.5.0 may be referred.

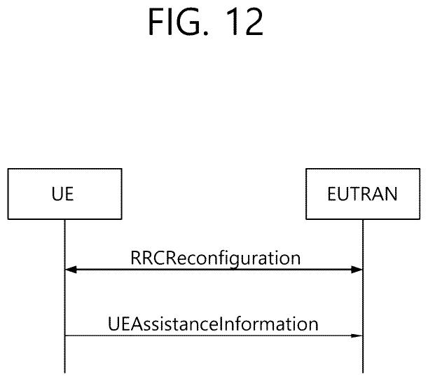

FIG. 12 shows an example of UE Assistance Information.

The purpose of this procedure is for the UE to inform the network of:
its delay budget report carrying desired increment/decrement in the connected mode DRX cycle length, or,
its overheating assistance information, or;
its IDC assistance information, or;
its preference on DRX parameters for power saving, or;
its preference on the maximum aggregated bandwidth for power saving, or;
its preference on the maximum number of secondary component carriers for power saving, or;
its preference on the maximum number of MIMO layers for power saving, or;
its preference on the minimum scheduling offset for cross-slot scheduling for power saving, or;
its preference on the RRC state, or;
configured grant assistance information for NR sidelink communication, or;
its preference in being provisioned with reference time information, or;
its preference for FR2 UL gap, or;
its preference to transition out of RRC_CONNECTED state for MUSIM operation, or;
its preference on the MUSIM gaps, or;
its relaxation state for RLM measurements, or;
its relaxation state for BFD measurements, or;
availability of data mapped to radio bearers which are not configured for SDT, or;
its preference for the SCG to be deactivated, or;
indicate that the UE has uplink data to transmit for a DRB for which there is no MCG RLC bearer while the SCG is deactivated, or;
change of its fulfilment status for RRM measurement relaxation criterion.

Hereinafter, technical features related to Details of memberOfTriggeringCells are described.

In particular, details of memberOfTriggeringCells, a4-a5-reportOnLeave and their joint behaviour.

The number of cells that should jointly meet the event entry condition is used as follows:

If the number of cells in the cellsTriggeredList is larger or equal to memberOfTriggeringCells, those cells should be included in the measurement report for this configured measurement

While a4-a5-reportOnLeave has been used in the specification according to such principle:

If a4-a5-reportOnLeave is configured and set to TRUE for event A4 or event A5 in the report configuration, UE reports the current cellsTriggeredList

It effectively means the first report will occur at the time when memberOfTriggeringCells (larger than 1) fulfills the event reporting criteria, whereas any subsequent reporting may happen only if any of the cells that triggered the event, cease to fulfill previously met condition.

### Evaluation of Enhanced Reporting for Interference Detection

Meanwhile, since aerial UEs experience line-of-sight propagation conditions to more cells as the altitude increase, faraway cells become more visible to aerial UEs. So, aerial UEs will receive interference from more cells in the downlink and will cause interference to more cells in the uplink.

In LTE, a threshold of the number of triggering cells (numberOfTriggeringCells) was introduced to prevent a lot of measurement reports as the altitude increases. As per the LTE specification, UE can send a measurement report when the number of cells satisfying a reporting configuration for the corresponding measurement identity is larger than the threshold. However, this legacy procedure is insufficient to inform the downlink interference to the network.

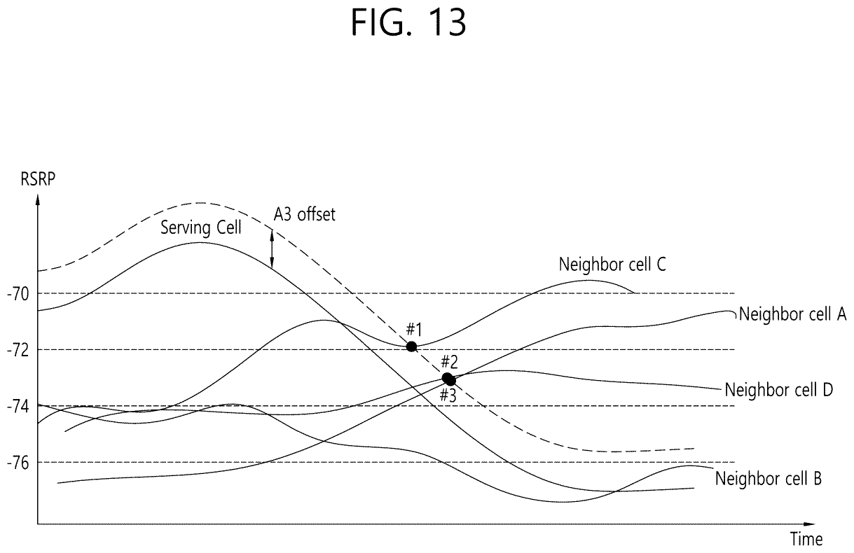

FIG. 13 shows an example of event A3.

In this example of FIG. 13, numberOfTriggeringCells is 4 and MR is not triggered

For example, for event A3 and event A5, the cell quality of the SpCell affects the event trigger. In this case, if the cell quality of the SpCell is sufficiently good, it is hard to trigger the measurement report for interference detection due to the limitation by the value of numberOfTriggeringCells even if interference from neighbor cells is detected.

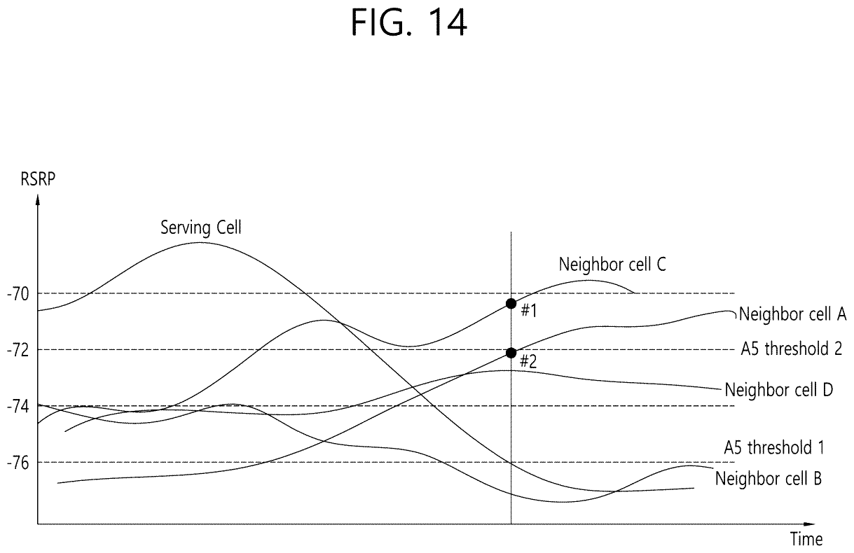

FIG. 14 shows an example of event A5.

In this example of FIG. 14, numberOfTriggeringCells is 4 and MR is not triggered

For example, for event 4, if the value of numberOfTriggeringCells is large, it has the same problem as event A3 and event A5. Even if interference from neighbor cells is detected, measurement reporting may not be triggered if the number of triggering cells does not satisfy the corresponding value.

Thus, a method for sending a measurement report efficiently considering downlink interference while reducing uplink interference with numberOfTriggeringCells is needed.

By considering the total number of cells triggered from each reporting condition, the UE can report the measurement report to inform the downlink interference. If the legacy procedure focuses on the uplink interference, it can be complementary for informing the downlink interference.

Therefore, studies for measurements reporting in a wireless communication system are required.

Hereinafter, a method for measurements reporting in a wireless communication system, according to some embodiments of the present disclosure, will be described with reference to the following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings. Herein, a wireless device may be referred to as a user equipment (UE).

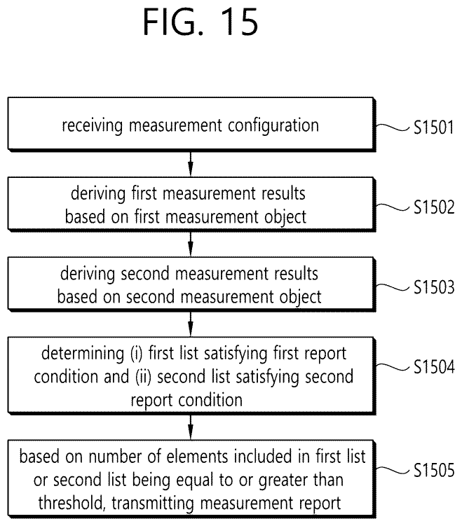

FIG. 15 shows an example of a method for measurements reporting in a wireless communication system, according to some embodiments of the present disclosure.

In particular, FIG. 15 shows an example of a method performed by a wireless device in a wireless communication system.

In step S1501, a wireless device may receive a measurement configuration including at least one measurement object, at least one report condition, and at least one measurement identity (ID).

For example, each measurement ID may be related to a measurement object and a report condition. For example, a first measurement ID is related to a first measurement object and a first report condition. For example, a second measurement ID is related to a second measurement object and a second report condition. For example, a third measurement ID is related to a third measurement object and a third report condition.

For example, when measurement results on the first measurement object satisfies the first report condition, the wireless device may transmit a measurement report including information on the first measurement ID.

For example, when measurement results on the second measurement object satisfies the second report condition, the wireless device may transmit a measurement report including information on the second measurement ID.

For example, when measurement results on the third measurement object satisfies the third report condition, the wireless device may transmit a measurement report including information on the third measurement ID. For example, the measurement configuration may include association information informing that the second measurement ID is associated with the first measurement ID. For example, the association information may inform that a mutual report condition associated with the first report condition and the second condition is configured for a new measurement report.

For example, the measurement configuration may include association information informing that the third measurement ID is associated with the first measurement ID and the second measurement ID.

For example, the third measurement ID may be configured as a mutual measurement ID based on the first measurement ID and the second measurement ID.

In step S1502, a wireless device may derive first measurement results based on a first measurement object related to a first measurement ID.

For example, the wireless device may perform measurements on at least one cell and/or at least one reference signal corresponding to the first measurement object.

In step S1503, a wireless device may derive second measurement results based on a second measurement object related to a second measurement ID.

For example, the wireless device may perform measurements on at least one cell and/or at least one reference signal corresponding to the second measurement object.

For example, the first measurement results may be based on measurements at a first time period. The second measurement results may be based on measurements at a second time period different from the first time period. The second time period may be different from the first time period.

In step S1504, a wireless device may determine (i) a first list satisfying a first report condition related to the first measurement ID based on the first measurement results and (ii) a second list satisfying a second report condition related to the second measurement ID based on the second measurement results.

For example, the first list may include at least one cell and/or at least one reference signal satisfying the first report condition. The second list may include at least one cell and/or at least one reference signal satisfying the second report condition.

For example, the at least one reference signal may include a Channel State Information-Reference Signal (CSI-RS) and/or a Synchronization Signal/PBCH block (SSB).

In step S1505, based on a number of elements included in any one of the first list and the second list being equal to or greater than a threshold, a wireless device may transmit a measurement report including (i) information related to the first list and the second list and (ii) information related to the first measurement ID and the second measurement ID.

For example, information on the threshold may be included in the measurement configuration.

For example, the transmitted measurement report may be related the third measurement ID. For example, the information related to the first measurement ID and the second measurement ID may include information on the third measurement ID.

For example, the measurement configuration may include a report condition related to the third measurement ID. The report condition related to the third measurement ID may be satisfied based on the number of elements included in any one of the first list and the second list being equal to or greater than a threshold.

According to some embodiments of the present disclosure, the wireless device may determine that the first measurement results does not satisfy the first report condition. The wireless device may determine that the second measurement results does not satisfy the second report condition.

When both the first report condition and the second report condition are not satisfied, the wireless device may determine whether the number of elements included in at least one or the first list and the second list being equal to or greater than a threshold. If the number of elements included in any one of the first list and the second list is equal to or greater than a threshold, that is, if the third report condition is satisfied, the wireless device may transmit the measurement report.

According to some embodiments of the present disclosure, based on sum of a number of elements included in the first list and a number of elements included in the second list being equal to or greater than a threshold, the wireless device may transmit a measurement report including (i) information related to the first list and the second list and (ii) information related to the first measurement ID and the second measurement ID.

According to some embodiments of the present disclosure, the wireless device may be in communication with at least one of a user equipment, a network, or an autonomous vehicle other than the wireless device.

Hereinafter, some embodiments for measurements reporting in a wireless communication system are described.

In the legacy procedure, UE includes the cell(s) satisfying measurement reporting condition in the cells triggered list (cellsTriggeredList) for associated measurement identity. If the number of cells in cellsTriggeredList is larger than a threshold, UE sends a measurement report for associated measurement identity.

However, there is a case where the UE cannot inform the downlink interference even if a large interference from a neighbor cell is detected, due to the lack of the number of triggering cells being separately considered in each reporting condition of corresponding measurement identity.

The present disclosure introduces a measurement reporting that takes into account the number of triggering cells of two or more measurement identities in order to give an opportunity to report downlink interference, even when the number of cells for separate measurement identity is not sufficient to report.

In the present disclosure, the network configures one or more thresholds for a measurement reporting. When the number of triggering cells of associated two or more measurement identities is larger than an applicable threshold, UE sends a measurement report for those measurement identities.

For association of measurement identities subject to the measurement reporting based on the threshold, the following may be considered:
A special type of a report configuration may be configured to the UE to configure a reporting event based on associated multiple measurement identifies, where the report configuration includes a threshold and associated measurement identifies that are affected by the threshold. In this method, if the total number of triggered cells of all the associated measurement identifies is larger than the threshold, the reporting event of the special type of reporting configuration is considered to be satisfied; or
A special type of a report configuration may be configured to the UE to configure a reporting event based on associated multiple measurement identifies, where the report configuration includes associated measurement identifies that are affected by the threshold. In addition, for each associated measurement identity, a separate threshold is configured. In this method, if the total number of triggered cells of all the associated measurement identifies is larger than the sum of the thresholds of all the associated measurement identifies, the reporting event of the special type of reporting configuration is considered to be satisfied.

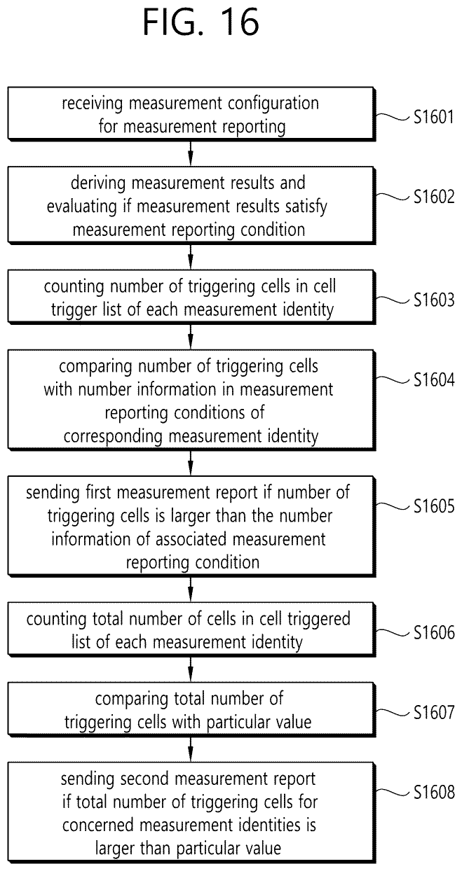

FIG. 16 shows some an example of a method for measurements reporting in a wireless communication system, according to some embodiments of the present disclosure.

In particular, FIG. 16 shows an example of a method performed by a wireless device in a wireless communication system.

In step S1601, the UE may receive, from a network, a measurement configuration for measurement reporting.

That is, a network may configure UE with measurement configuration for measurement reporting.
1> The measurement configuration may include measurement object(s) and measurement reporting condition(s)
1> A measurement object and a measurement reporting condition are linked to a measurement identity
1> The measurement configuration may include number information
2> The number information includes the number of triggering cells for a measurement report, denoted by N 1> The measurement configuration may include total number information
2> The total number information includes the total number of triggering cells for a measurement report, denoted by M
2> ALT1: The total number information is common to all measurement reporting conditions
2> ALT2: The total number information is configured in each measurement reporting condition
1> For example, measurement configuration may comprise the following for ALT1:
2> Total number information M
2> MeasObject #1
3> Measurement object parameters in TS 38.331 v17.0.0
2> MeasObject #2
3> Measurement object parameters in TS 38.331 v17.0.0
2> ReportConfig #1
3> Measurement reporting parameters in TS 38.331 v17.0.0
3> Number information N1
2> ReportConfig #2
3> Measurement reporting parameters in TS 38.331 v17.0.0
3> Number information N2
2> ReportConfig #3
3> Measurement reporting parameters in TS 38.331 v17.0.0
2> MeasId #1
3> MO #1
3> ReportConfig #1
2> MeasId #2
3> MO #1
3> ReportConfig #2
2> MeasId #3
3> MO #2
3> ReportConfig #2
2> MeasId #4
3> MO #2
3> ReportConfig #3
2> In this example,
3> Based on the measurement ID #1, the measurement object #1 is associated with N1 with respect to report configuration #1 and M of the total number information
3> Based on the measurement ID #2, the measurement object #1 is associated with N2 with respect to report configuration #2 and M of the total number information
3> Based on the measurement ID #3, the measurement object #2 is associated with N2 with respect to report configuration #2 and M of the total number information
1> For example, measurement configuration may comprise the following for ALT2:
2> MeasObject #1
3> Measurement object parameters in TS 38.331 v17.0.0
2> MeasObject #2
3> Measurement object parameters in TS 38.331 v17.0.0
2> ReportConfig #1
3> Measurement reporting parameters in TS 38.331 v17.0.0
3> Number information N1
3> Total number information M1
2> ReportConfig #2
3> Measurement reporting parameters in TS 38.331 v17.0.0
3> Number information N2
3> Total number information M2
2> MeasId #1
3> MO #1
3> ReportConfig #1
2> MeasId #2
3> MO #1
3> ReportConfig #2
2> MeasId #3
3> MO #2
3> ReportConfig #2
2> In this example,
3> Based on the measurement ID #1, the measurement object #1 is associated with N1 and M1 with respect to report configuration #1
3> Based on the measurement ID #2, the measurement object #1 is associated with N2 and M2 with respect to report configuration #2
3> Based on the measurement ID #3, the measurement object #2 is associated with N2 and M2 with respect to report configuration #2

In step S1602, the UE may derive the measurement results and evaluates if the measurement results satisfy the measurement reporting condition of the corresponding measurement identity.
1> If the measurement results satisfy the measurement reporting condition, UE includes the concerned cell(s) in the cell trigger list, denoted by Lₓ, where Lₓ indicates the list of the triggering cells for the measurement ID x

In step S1603, the UE may count the number of triggering cells in the cell trigger list (=Lₓ) of each measurement identity.
1> The number of cells of each cell triggered list is denoted by nₓ, where nₓ indicates the number of the triggering cells for the measurement ID x

In step S1604, the UE may compare the number of triggering cells with the number information in measurement reporting conditions of corresponding measurement identity.
1> For examples:
2> UE compares n₁ with N1
2> UE compares n₂ with N2
2> UE compares n₃ with N2

In step S1605, the UE may send a first measurement report if the number of triggering cells is larger than the number information of associated measurement reporting condition.
1> For examples:
2> If n₁ is larger than N1, UE sends a measurement report for measurement ID #1
2> If n₂ is larger than N2, UE sends a measurement report for measurement ID #2
2> If n₃ is larger than N2, UE sends a measurement report for measurement ID #3

In step S1606, the UE may count the total number of cells in cell triggered list of each measurement identity.
1> This operation may be applied only to the measurement identity associated with the reporting condition including number information N
1> This operation may be applied to two or more cell triggered lists
2> Network may configure the combination of measurement identity
2> UE may select the combination of measurement identity
1> UE counts the total number of cells as follows:
2> UE may count the total number of cells from each cell triggered list
2> UE may count the total number of cells except for duplicates among cells in each cell triggered list
1> The total number of cells of each cell triggered list is denoted by m_{xy}, where m_{xy} indicates the total number of the triggering cells for the measurement ID x and the measurement ID y without loss of generality. If there are more than two measurement IDs are associated, it can be extended to m_{xyz} . . . .

In step S1607, the UE may compare the total number of triggering cells with a particular value as follow:
1> For example for ALT1, UE compares the total number of triggering cells with M
2> UE compares m₁₂ with M
2> UE compares m₁₃ with M
2> UE compares m₂₃ with M
2> UE compares m₁₂₃ with M
1> For example for ALT2, UE compares the total number of triggering cells with a sum of total number information in measurement reporting condition of associated measurement identity
2> UE compares m₁₂ with M1+M2
2> UE compares m₁₃ with M1+M2
2> UE compares m₂₃ with M2+M2
2> UE compares m₁₂₃ with M1+M2+M2

In step S1608, the UE may send a second measurement report if the total number of triggering cells for concerned measurement identities is larger than the particular value.
1> UE may send the second measurement report only when the first measurement report was not sent for the corresponding measurement identity
1> For example for ALT1:
2> If m₁₂ is larger than M, UE sends a measurement report for measurement ID #1 and measurement ID #2
2> If m₁₃ is larger than M, UE sends a measurement report for measurement ID #1 and measurement ID #3
2> If m₂₃ is larger than M, UE sends a measurement report for measurement ID #2 and measurement ID #3
2> If m₁₂₃ is larger than M, UE sends a measurement report for measurement ID #1, measurement ID #2, and measurement ID #3
1> For example for ALT2:
2> If m₁₂ is larger than M1+M2, UE sends a measurement report for measurement ID #1 and measurement ID #2
2> If m₁₃ is larger than M1+M2, UE sends a measurement report for measurement ID #1 and measurement ID #3
2> If m₂₃ is larger than M2+M2, UE sends a measurement report for measurement ID #2 and measurement ID #3
2> If m₁₂₃ is larger than M1+M2+M2, UE sends a measurement report for measurement ID #1, measurement ID #2, and measurement ID #3

According to some embodiments of the present disclosure, a wireless device may receive measurement configuration including measurement object(s), report configurations, and one or more measurement IDs, where each measurement ID associates a measurement object and a report configuration. A wireless device may derive measurement results of one or more cell corresponding to a measurement object. A wireless device may evaluate the number of triggering cells that satisfy the reporting condition of each measurement ID. A wireless device may send a measurement report if the number of triggering cells of two or more measurement IDs is larger than a threshold.

Hereinafter, examples of a method for measurements reporting in a wireless communication system are described.

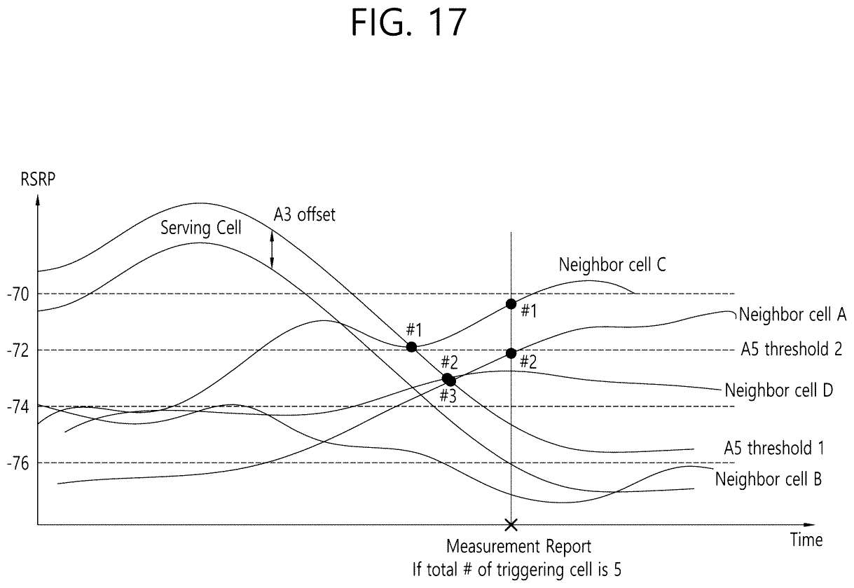

FIG. 17 shows an example of triggering measurement report by total number of triggering cell.

### <Example 1> Measurement Report Triggered by ALT1

The network does not configure the combination of measurement identity for total number of cells
The measurement report triggered by N was not sent
1) The network configures measurement configuration including measurement objects and measurement report configurations.
> The network configures total number information M (=5)
> For measurement ID #1, measurement report configuration includes event A3, number information N₁(=4)
> For measurement ID #2, measurement report configuration includes event A5, number information N2 (=4)
2) UE derives the measurement results
3) UE includes the concerned cell in the cell triggering list of each measurement identity if the measurement results satisfy the measurement reporting condition of the corresponding measurement identity
> For measurement ID #1, the number of triggering cells is 3
> For measurement ID #2, the number of triggering cells is 2
> For each measurement IDs, the number of triggering cells does not satisfy the number information

$$≫ {n}_{1} ( 3 ) < {N}_{1} ( 4 ) , {n}_{2} ( 2 ) < {N}_{2} ( 4 )$$

4) UE evaluates the total number of triggering cells of two or more measurement identities
> For measurement ID #1 and measurement ID #2, the total number of triggering cells satisfy the total number information M

$$≫ {m}_{12} ( 5 ) \geq M ( 5 )$$

5) UE sends a measurement report triggered by total number of triggering cells
> The measurement report is for measurement ID #1 and measurement ID #2

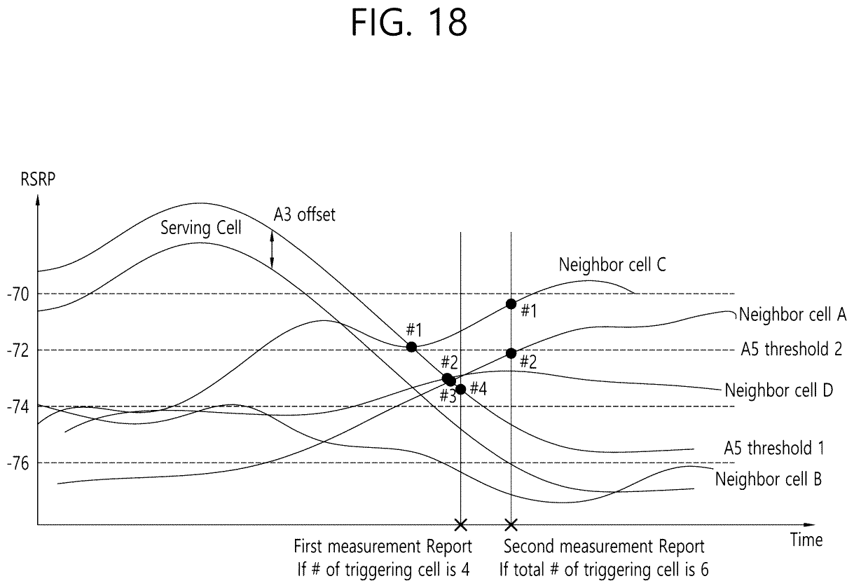

FIG. 18 shows an example of triggering measurement report by total number of triggering cell.

### <Example 2> Measurement Report Triggered by ALT1

The network does not configure the combination of measurement identity for total number of cells
The measurement report triggered by N was sent
1) The network configures measurement configuration including measurement objects and measurement report configurations.
> The network configures total number information M(=6)
> For measurement ID #1, measurement report configuration includes event A3, number information N₁(=4)
> For measurement ID #2, measurement report configuration includes event A5, number information N2 (=4)
2) UE derives the measurement results
3) UE includes the concerned cell in the cell triggering list of each measurement identity if the measurement results satisfy the measurement reporting condition of the corresponding measurement identity
> For measurement ID #1, the number of triggering cells is 4
> For measurement ID #2, the number of triggering cells is 2
4) UE sends a first measurement report if the number of cells triggering list is more than the number information of associated reporting condition
> The first measurement report is for the measurement ID #1
5) UE keeps deriving the measurement results
6) UE evaluates the total number of triggering cells of two or more measurement identities
> For measurement ID #1 and measurement ID #2, the total number of triggering cells satisfies the total number information M

$$≫ {m}_{12} ( 5 ) \geq M ( 5 )$$

7) UE sends a second measurement report triggered by total number of cells
> The second measurement report is for measurement ID #1 and measurement ID #2

### <Example 3> Measurement Report Triggered by ALT2

The network configures the combination of measurement identity for total number of cells
The measurement report triggered by N was not sent
1) The network configures measurement configuration including measurement objects and measurement report configurations.
> For measurement ID #1, measurement report configuration includes event A3, number information N₁(=4), total number information M₁(=2)
> For measurement ID #2, measurement report configuration includes event A5, number information N₂ (=4), total number information M₂ (=3)
> Measurement configuration includes combination information of measurement identity. For example, the combination information indicates measurement ID #1 and measurement ID #2
2) UE derives the measurement results
3) UE includes the concerned cell in the cell triggering list of each measurement identity if the measurement results satisfy the measurement reporting condition of the corresponding measurement identity
> For measurement ID #1, the number of triggering cell is 3
> For measurement ID #2, the number of triggering cell is 2
> For each measurement IDs, the number of triggering cells does not satisfy the number information

$$≫ {n}_{1} ( 3 ) < {N}_{1} ( 4 ) , {n}_{2} ( 2 ) < {N}_{2} ( 4 )$$

4) According to the combination information, UE evaluates the total number of triggering cells of corresponding measurement identities and compares the total number with a sum of total number information of associated measurement identities
> For measurement ID #1 and measurement ID #2, the total number of triggering cells satisfies the total number information M₁+M₂

$$≫ {m}_{12} ( 5 ) \geq {M}_{1} ( 2 ) + {M}_{2} ( 3 )$$

5) UE sends a measurement report triggered by total number of cell
> The measurement report is for measurement ID #1 and measurement ID #2

### <Example 4> Measurement Report Triggered by ALT2

The network configures the combination of measurement identity for total number of cells
The measurement report triggered by N was sent
1) The network configures measurement configuration including measurement objects and measurement report configurations.
> For measurement ID #1, measurement report configuration includes event A3, number information N₁(=4), total number information M₁(=2)
> For measurement ID #2, measurement report configuration includes event A5, number information N₂ (=4), total number information M₂ (=3)
> Measurement configuration includes combination information of measurement identity. For example, the combination information indicates measurement ID #1 and measurement ID #2
2) UE derives the measurement results
3) UE includes the concerned cell in the cell triggering list of each measurement identity if the measurement results satisfy the measurement reporting condition of the corresponding measurement identity
> For measurement ID #1, the number of triggering cells is 4
> For measurement ID #2, the number of triggering cells is 2
4) UE sends a first measurement report if the number of cells triggering list is more than the number information of associated reporting condition
> The first measurement report is for the measurement ID #1
5) UE keeps deriving the measurement results
6) According to the combination information, UE evaluates the total number of triggering cells of corresponding measurement identities and compares the total number with a sum of total number information of associated measurement identities
> For measurement ID #1 and measurement ID #2, the total number of triggering cells satisfies the total number information M₁+M₂

$$≫ {m}_{12} ( 5 ) \geq {M}_{1} ( 2 ) + {M}_{2} ( 3 )$$

7) UE sends a measurement report triggered by total number of cell
> The measurement report is for measurement ID #1 and measurement ID #2

Some of the detailed steps shown in the examples of FIGS. 15-18 may not be essential steps and may be omitted. In addition to the steps shown in FIGS. 15-18, other steps may be added, and the order of the steps may vary. Some of the above steps may have their own technical meaning.

Hereinafter, an apparatus for measurements reporting in a wireless communication system, according to some embodiments of the present disclosure, will be described. Herein, the apparatus may be a wireless device (100 or 200) in FIGS. 2, 3, and 5.

For example, a wireless device may perform the methods described above. The detailed description overlapping with the above-described contents could be simplified or omitted.

Referring to FIG. 5, a wireless device 100 may include a processor 102, a memory 104, and a transceiver 106.

According to some embodiments of the present disclosure, the processor 102 may be adapted to be coupled operably with the memory 104 and the transceiver 106.

The processor 102 may be adapted to control the transceiver 106 to receive a measurement configuration including at least one measurement object, at least one report condition, and at least one measurement identity (ID). Each measurement ID may be related to a measurement object and a report condition. The processor 102 may be adapted to derive first measurement results based on a first measurement object related to a first measurement ID. The processor 102 may be adapted to derive second measurement results based on a second measurement object related to a second measurement ID. The processor 102 may be adapted to determine (i) a first list satisfying a first report condition related to the first measurement ID based on the first measurement results and (ii) a second list satisfying a second report condition related to the second measurement ID based on the second measurement results. Based on a number of elements included in any one of the first list and the second list being equal to or greater than a threshold, the processor 102 may be adapted to control the transceiver 106 to transmit a measurement report including (i) information related to the first list and the second list and (ii) information related to the first measurement ID and the second measurement ID.

For example, the first list may include at least one cell and/or at least one reference signal satisfying the first report condition.

For example, the second list may include at least one cell and/or at least one reference signal satisfying the second report condition.

For example, the first measurement results may be based on measurements at a first time period, and the second measurement results may be based on measurements at a second time period different from the first time period. The second time period may be different from the first time period.

For example, the measurement configuration may include association information informing that the second measurement ID is associated with the first measurement ID.

For example, the measurement configuration may include association information informing that the third measurement ID is associated with the first measurement ID and the second measurement ID. The measurement report may be related the third measurement ID. The information related to the first measurement ID and the second measurement ID may include information on the third measurement ID.

For example, the measurement configuration may include a report condition related to the third measurement ID. The report condition related to the third measurement ID may be satisfied based on the number of elements included in any one of the first list and the second list being equal to or greater than a threshold.

For example, the third measurement ID may be configured as a mutual measurement ID based on the first measurement ID and the second measurement ID.

For example, the processor 102 may be adapted to determine that the first measurement results does not satisfy the first report condition; and determine that the second measurement results does not satisfy the second report condition. For example, the processor 102 may be adapted to determine whether the number of elements included in at least one or the first list and the second list being equal to or greater than a threshold.

According to some embodiments of the present disclosure, based on sum of a number of elements included in the first list and a number of elements included in the second list being equal to or greater than a threshold, the processor 102 may be adapted to transmit a measurement report including (i) information related to the first list and the second list and (ii) information related to the first measurement ID and the second measurement ID.

For example, the processor 102 may be adapted to control the transceiver 106 to be in communication with at least one of a user equipment, a network, or an autonomous vehicle other than the wireless device.

Hereinafter, a processor for a wireless device for measurements reporting in a wireless communication system, according to some embodiments of the present disclosure, will be described.

The processor may be adapted to control the wireless device to receive a measurement configuration including at least one measurement object, at least one report condition, and at least one measurement identity (ID). Each measurement ID may be related to a measurement object and a report condition. The processor may be adapted to control the wireless device to derive first measurement results based on a first measurement object related to a first measurement ID. The processor may be adapted to control the wireless device to derive second measurement results based on a second measurement object related to a second measurement ID. The processor may be adapted to control the wireless device to determine (i) a first list satisfying a first report condition related to the first measurement ID based on the first measurement results and (ii) a second list satisfying a second report condition related to the second measurement ID based on the second measurement results. Based on a number of elements included in any one of the first list and the second list being equal to or greater than a threshold, the processor may be adapted to control the wireless device to transmit a measurement report including (i) information related to the first list and the second list and (ii) information related to the first measurement ID and the second measurement ID.

For example, the first list may include at least one cell and/or at least one reference signal satisfying the first report condition.

For example, the second list may include at least one cell and/or at least one reference signal satisfying the second report condition.

For example, the first measurement results may be based on measurements at a first time period, and the second measurement results may be based on measurements at a second time period different from the first time period. The second time period may be different from the first time period.

For example, the measurement configuration may include association information informing that the second measurement ID is associated with the first measurement ID.

For example, the measurement configuration may include association information informing that the third measurement ID is associated with the first measurement ID and the second measurement ID. The measurement report may be related the third measurement ID. The information related to the first measurement ID and the second measurement ID may include information on the third measurement ID.

For example, the measurement configuration may include a report condition related to the third measurement ID. The report condition related to the third measurement ID may be satisfied based on the number of elements included in any one of the first list and the second list being equal to or greater than a threshold.

For example, the third measurement ID may be configured as a mutual measurement ID based on the first measurement ID and the second measurement ID.

For example, the processor may be adapted to control the wireless device to determine that the first measurement results does not satisfy the first report condition; and determine that the second measurement results does not satisfy the second report condition. For example, the processor may be adapted to control the wireless device to determine whether the number of elements included in at least one or the first list and the second list being equal to or greater than a threshold.

According to some embodiments of the present disclosure, based on sum of a number of elements included in the first list and a number of elements included in the second list being equal to or greater than a threshold, the processor may be adapted to control the wireless device to transmit a measurement report including (i) information related to the first list and the second list and (ii) information related to the first measurement ID and the second measurement ID.

For example, the processor may be adapted to control the wireless device to be in communication with at least one of a user equipment, a network, or an autonomous vehicle other than the wireless device.

Hereinafter, a non-transitory computer-readable medium has stored thereon a plurality of instructions for measurements reporting in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of a wireless device.

The stored a plurality of instructions may cause the wireless device to receive a measurement configuration including at least one measurement object, at least one report condition, and at least one measurement identity (ID). Each measurement ID may be related to a measurement object and a report condition. The stored a plurality of instructions may cause the wireless device to derive first measurement results based on a first measurement object related to a first measurement ID. The stored a plurality of instructions may cause the wireless device to derive second measurement results based on a second measurement object related to a second measurement ID. The stored a plurality of instructions may cause the wireless device to determine (i) a first list satisfying a first report condition related to the first measurement ID based on the first measurement results and (ii) a second list satisfying a second report condition related to the second measurement ID based on the second measurement results. Based on a number of elements included in any one of the first list and the second list being equal to or greater than a threshold, the stored a plurality of instructions may cause the wireless device to transmit a measurement report including (i) information related to the first list and the second list and (ii) information related to the first measurement ID and the second measurement ID.

For example, the first list may include at least one cell and/or at least one reference signal satisfying the first report condition.

For example, the second list may include at least one cell and/or at least one reference signal satisfying the second report condition.

For example, the first measurement results may be based on measurements at a first time period, and the second measurement results may be based on measurements at a second time period different from the first time period. The second time period may be different from the first time period.

For example, the measurement configuration may include association information informing that the second measurement ID is associated with the first measurement ID.

For example, the measurement configuration may include association information informing that the third measurement ID is associated with the first measurement ID and the second measurement ID. The measurement report may be related the third measurement ID. The information related to the first measurement ID and the second measurement ID may include information on the third measurement ID.

For example, the measurement configuration may include a report condition related to the third measurement ID. The report condition related to the third measurement ID may be satisfied based on the number of elements included in any one of the first list and the second list being equal to or greater than a threshold.

For example, the third measurement ID may be configured as a mutual measurement ID based on the first measurement ID and the second measurement ID.

For example, the stored a plurality of instructions may cause the wireless device to determine that the first measurement results does not satisfy the first report condition; and determine that the second measurement results does not satisfy the second report condition. For example, the stored a plurality of instructions may cause the wireless device to determine whether the number of elements included in at least one or the first list and the second list being equal to or greater than a threshold.

According to some embodiments of the present disclosure, based on sum of a number of elements included in the first list and a number of elements included in the second list being equal to or greater than a threshold, the stored a plurality of instructions may cause the wireless device to transmit a measurement report including (i) information related to the first list and the second list and (ii) information related to the first measurement ID and the second measurement ID.

For example, the stored a plurality of instructions may cause the wireless device to be in communication with at least one of a user equipment, a network, or an autonomous vehicle other than the wireless device.

Hereinafter, a method performed by a base station (BS) for measurements reporting in a wireless communication system, according to some embodiments of the present disclosure, will be described.

The BS may transmit, to a wireless device, a measurement configuration including at least one measurement object, at least one report condition, and at least one measurement identity (ID).

For example, each measurement ID may be related to a measurement object and a report condition. For example, first measurement results may be derived by the wireless device based on a first measurement object related to a first measurement ID. For example, second measurement results may be derived by the wireless device based on a second measurement object related to a second measurement ID. For example, (i) a first list satisfying a first report condition related to the first measurement ID based on the first measurement results and (ii) a second list satisfying a second report condition related to the second measurement ID based on the second measurement results may be determined by the wireless device.

The BS may receive, from the wireless device, a measurement report including (i) information related to the first list and the second list and (ii) information related to the first measurement ID and the second measurement ID, based on a number of elements included in any one of the first list and the second list being equal to or greater than a threshold.

Hereinafter, a base station (BS) for measurements reporting in a wireless communication system, according to some embodiments of the present disclosure, will be described.

The BS may include a transceiver, a memory, and a processor operatively coupled to the transceiver and the memory.

The processor may be adapted to control the transceiver to transmit, to a wireless device, a measurement configuration including at least one measurement object, at least one report condition, and at least one measurement identity (ID).

For example, each measurement ID may be related to a measurement object and a report condition. For example, first measurement results may be derived by the wireless device based on a first measurement object related to a first measurement ID. For example, second measurement results may be derived by the wireless device based on a second measurement object related to a second measurement ID. For example, (i) a first list satisfying a first report condition related to the first measurement ID based on the first measurement results and (ii) a second list satisfying a second report condition related to the second measurement ID based on the second measurement results may be determined by the wireless device.

The processor may be adapted to control the transceiver to receive, from the wireless device, a measurement report including (i) information related to the first list and the second list and (ii) information related to the first measurement ID and the second measurement ID, based on a number of elements included in any one of the first list and the second list being equal to or greater than a threshold.

The present disclosure can have various advantageous effects.

According to some embodiments of the present disclosure, a wireless device could efficiently perform measurements reporting considering at least two measurement conditions.

For example, the UE may report downlink interference by reporting a measurement report in consideration of the total number of cells triggered in each reporting condition. If the legacy procedure focuses on uplink interference, it can be a supplement to inform downlink interference.

For example, even if the number of triggering cells independently considered for each reporting condition is not sufficient, the UE can efficiently report DL interference by considering the total number of triggering cells that satisfy each reporting condition.

According to some embodiments of the present disclosure, a wireless network system could provide an efficient solution for measurements reporting considering at least two measurement conditions.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method, comprising:
receiving, by a wireless device, a measurement configuration including at least one measurement object, at least one report condition, and at least one measurement identity (ID),
wherein each measurement ID is related to a measurement object and a report condition;
deriving, by the wireless device, first measurement results based on a first measurement object related to a first measurement ID;
deriving, by the wireless device, second measurement results based on a second measurement object related to a second measurement ID;
determining, by the wireless device, (i) a first list satisfying a first report condition related to the first measurement ID based on the first measurement results and (ii) a second list satisfying a second report condition related to the second measurement ID based on the second measurement results; and
based on a number of elements included in any one of the first list and the second list being equal to or greater than a threshold, transmitting, by the wireless device, a measurement report including (i) information related to the first list and the second list and (ii) information related to the first measurement ID and the second measurement ID.

2. The method of claim 1,
wherein the first list includes at least one cell and/or at least one reference signal satisfying the first report condition.

3. The method of claim 1,
wherein the second list includes at least one cell and/or at least one reference signal satisfying the second report condition.

4. The method of claim 1,
wherein the first measurement results are based on measurements at a first time period, and
wherein the second measurement results are based on measurements at a second time period different from the first time period.

5. The method of claim 4,
wherein the second time period is different from the first time period.

6. The method of claim 1,
wherein the measurement configuration includes association information informing that the second measurement ID is associated with the first measurement ID.

7. The method of claim 1,
wherein the measurement configuration includes association information informing that the third measurement ID is associated with the first measurement ID and the second measurement ID.

8. The method of claim 7,
wherein the measurement report is related the third measurement ID, and
wherein the information related to the first measurement ID and the second measurement ID includes information on the third measurement ID.

9. The method of claim 7,
wherein the measurement configuration includes a report condition related to the third measurement ID, and
wherein the report condition related to the third measurement ID is satisfied based on the number of elements included in any one of the first list and the second list being equal to or greater than a threshold.

10. The method of claim 7,
wherein the third measurement ID is configured as a mutual measurement ID based on the first measurement ID and the second measurement ID.

11. The method of claim 1, wherein the method further comprises,
determining, by the wireless device, that the first measurement results does not satisfy the first report condition; and
determining, by the wireless device, that the second measurement results does not satisfy the second report condition.

12. The method of claim 11, wherein the method further comprises,
determining, by the wireless device, whether the number of elements included in at least one or the first list and the second list being equal to or greater than a threshold.

13. The method of claim 1, wherein the method further comprises,
based on sum of a number of elements included in the first list and a number of elements included in the second list being equal to or greater than a threshold, transmitting, by the wireless device, a measurement report including (i) information related to the first list and the second list and (ii) information related to the first measurement ID and the second measurement ID.

14. The method of claim 1,
wherein the wireless device is in communication with at least one of a user equipment, a network, or an autonomous vehicle other than the wireless device.

15. A wireless device, comprising:
a transceiver;
a memory; and
at least one processor operatively coupled to the transceiver and the memory, and adapted to:
control the transceiver to receive a measurement configuration including at least one measurement object, at least one report condition, and at least one measurement identity (ID),
wherein each measurement ID is related to a measurement object and a report condition;
derive first measurement results based on a first measurement object related to a first measurement ID;
derive second measurement results based on a second measurement object related to a second measurement ID;
determine (i) a first list satisfying a first report condition related to the first measurement ID based on the first measurement results and (ii) a second list satisfying a second report condition related to the second measurement ID based on the second measurement results; and
based on a number of elements included in any one of the first list and the second list being equal to or greater than a threshold, control the transceiver to transmit a measurement report including (i) information related to the first list and the second list and (ii) information related to the first measurement ID and the second measurement ID.

16. The wireless device of claim 15,
wherein the first list includes at least one cell and/or at least one reference signal satisfying the first report condition.

17. The wireless device of claim 15,
wherein the second list includes at least one cell and/or at least one reference signal satisfying the second report condition.

18. The wireless device of claim 15,
wherein the first measurement results are based on measurements at a first time period, and
wherein the second measurement results are based on measurements at a second time period different from the first time period.

19. The wireless device of claim 18,
wherein the second time period is different from the first time period.

20.-31. (canceled)

32. A base station, comprising:
a transceiver;
a memory; and
a processor operatively coupled to the transceiver and the memory, and adapted to:
transmit, to a wireless device, a measurement configuration including at least one measurement object, at least one report condition, and at least one measurement identity (ID),
wherein each measurement ID is related to a measurement object and a report condition,
wherein first measurement results are derived by the wireless device based on a first measurement object related to a first measurement ID,
wherein second measurement results are derived by the wireless device based on a second measurement object related to a second measurement ID, and
wherein (i) a first list satisfying a first report condition related to the first measurement ID based on the first measurement results and (ii) a second list satisfying a second report condition related to the second measurement ID based on the second measurement results are determined by the wireless device; and
receive, from the wireless device, a measurement report including (i) information related to the first list and the second list and (ii) information related to the first measurement ID and the second measurement ID, based on a number of elements included in any one of the first list and the second list being equal to or greater than a threshold.
